(19) United States
(12) Patent Application Publication
(10) Pub. No.: US 2024/0026966 A1
(43) Pub. Date: Jan. 25, 2024

(54) DIFFERENTIAL DEVICE

(71) Applicant: MUSASHI SEIMITSU INDUSTRY CO., LTD., TOYOHASHI-SHI, AICHI (JP)

(72) Inventors: Hirohisa ODA, TOYOHASHI-SHI, AICHI (JP); Akuto SEKIGUCHI, TOYOHASHI-SHI, AICHI (JP)

(21) Appl. No.: 18/025,008

(22) PCT Filed: Sep. 8, 2020
(86) PCT No.: PCT/JP2020/033977

§ 371 Date: Mar. 7, 2023

(51) Int. Cl. F16H 57/04

(52) U.S. Cl. CPC F16H 57/0424; F16H 57/0483

(57) ABSTRACT

There is provided a differential device including a differential case, side gears, two or more pinion gears, and oil introduction channels. In the differential device (D), an inner surface (Ci) of the differential case (C) includes pinion gear support surfaces (P1, P2) supporting back sides of the respective two or more pinion gears (22), inner surface oil grooves (Gi1, Gi2) provided in the inner surface at positions outward of the respective pinion gear support surfaces and communicating with the oil introduction channels (15, 16), pinion gear lubricating oil grooves (Gp) provided to the pinion gear support surfaces and having one ends opened to the inner surface oil grooves, and discharge channels (O1, O2) making the other ends of the pinion gear lubricating oil grooves communicate with an internal space (17) of the differential case.

### TECHNICAL FIELD

The present invention relates to a differential device, particularly a differential device comprising a differential case rotatable about a first axial line, side gears in pairs supported by the differential case in a freely rotatable manner about the first axial line, two or more pinion gears supported by the differential case in a freely rotatable manner about at least one second axial line orthogonal to the first axial line and meshing with the respective side gears in pairs, and oil grooves provided in an inner surface of the differential case so as to carry oil between side gear support surfaces and pinion gear support surfaces of the differential case.

### BACKGROUND ART

The differential device described above has been conventionally known as disclosed in, for example, Patent Document 1.

There is also a conventionally known oil introduction structure to provide a differential case with oil introduction channels capable of introducing oil from the outside of the differential case into oil grooves in side gear support surfaces, in a differential device in which side gears and pinion gears are housed in the differential case in a freely rotatable manner.

### PRIOR ART DOCUMENTS

### Patent Documents

Patent Document 1: Japanese Patent Publication No. 6625778

### SUMMARY OF THE INVENTION

### Problems to be Solved by the Invention

It is considered to apply the conventionally known oil introducing structure to the differential device of Patent Document 1 so as to enable supply of the oil not only to the side gear support surfaces but also to the pinion gear support surfaces from the oil introduction channels.

In the differential device of Patent Document 1, however, the oil grooves provided in the pinion gear support surfaces are terminated without extending across the pinion gear support surfaces. Thus, even when fresh oil flows through the oil grooves from the side gears, the fresh oil does not easily flow toward the pinion gear support surfaces due to the air and the oil remained and stagnated in the oil grooves. This causes a problem that back sides of the pinion gears cannot be sufficiently lubricated and cooled.

The present invention is made in light of circumstances discussed above, and has an object to provide a differential device that can solve the above problem with a simple structure.

### Means for Solving the Problems

In order to achieve the above-described object, the present invention has a first feature to provide a differential device. The differential device comprises: a differential case rotatable about a first axial line; side gears in pairs that are supported by the differential case in a freely rotatable manner about the first axial line; two or more pinion gears supported by the differential case in a freely rotatable manner about at least one second axial line orthogonal to the first axial line and meshing with the respective side gears in pairs; oil introduction channels provided to the differential case so as to enable introduction of lubricating oil from an outside of the differential case to respective side gear support surfaces of the inner surface of the differential case. The respective side gear support surfaces support back sides of the side gears. In the differential device, the inner surface of the differential case includes: pinion gear support surfaces supporting back sides of the two or more pinion gears; inner surface oil grooves, each of which is provided in the inner surface at a position outward of a corresponding one of the pinion gear support surfaces; pinion gear lubricating oil grooves provided in the respective pinion gear support surfaces, each pinion gear lubricating oil groove including one end opened to a corresponding one of the inner surface oil grooves; and discharge channels, each of which makes another end of the corresponding one of the pinion gear lubricating oil grooves communicate with an internal space of the differential case.

In addition to the first feature, the present invention has a second feature in which the each pinion gear lubricating oil groove passes through a radially-inward specific area in a corresponding one of the pinion gear support surfaces. The radially-inward specific area is positioned radially inward of an imaginary circle that bisects a radial width of the corresponding one of the pinion gear support surfaces.

In addition to the first or second feature, the present invention has a third feature in which the each pinion gear lubricating oil groove is formed so as to linearly extend as viewed in a projection plane orthogonal to the second axial line. Furthermore, the each pinion gear lubricating oil groove intersects an imaginary straight line orthogonal to the first axial line and the second axial line as viewed in the projection plane.

In addition to any one of the first to third features, the present invention has a fourth feature in which the differential case includes boss parts in pairs as parts integral with the differential case. Each boss part is fitted with and supports a corresponding one of output shafts in pairs so as to make the corresponding one of the output shafts freely rotatable. Each output shaft rotates with a corresponding one of the side gears in pairs in an interlocking manner. The boss parts include inner circumferential surfaces provided with the respective oil introduction channels. First inner surface oil grooves of the inner surface oil grooves communicating with a first oil introduction channel of the oil introduction channels, first pinion gear lubricating oil grooves of the pinion gear lubricating oil grooves communicating with the respective first inner surface oil grooves, and first discharge channels of the discharge channels communicating with the respective first pinion gear lubricating oil grooves are included in first channels. A second inner surface oil groove of the inner surface oil grooves communicating with a second oil introduction channel of the oil introduction channels, a second pinion gear lubricating oil groove of the pinion gear lubricating oil grooves communicating with the second inner surface oil groove, and a second discharge channel of the discharge channels communicating with the second pinion gear lubricating oil groove are included in a second channel. The first channels and the second channel are arranged in the inner surface of the differential case independently from each other.

In addition to any one of the first to third features, the present invention has a fifth feature in which the differential case includes boss parts in pairs as parts integral with the differential case. Each boss part is fitted with and supports a corresponding one of output shafts in pairs so as to make the corresponding one of the output shafts freely rotatable. Each output shaft rotates with a corresponding one of the side gears in pairs in an interlocking manner. The boss parts include inner circumferential surfaces provided with the respective oil introduction channels. The oil introduction channels include a first oil introduction channel and a second oil introduction channel. First inner surface oil grooves of the inner surface oil grooves communicating with the first oil introduction channel of the oil introduction channels and second inner surface oil grooves of the inner surface oil grooves communicating with the second oil introduction channel of the oil introduction channels are provided in the inner surface of the differential case so as to communicate with each other through the respective pinion gear lubricating oil grooves. When the lubricating oil is introduced into the pinion gear lubricating grooves from the first oil introduction channel through the first inner surface oil grooves, the second inner surface oil grooves function as the discharge channels. When the lubricating oil is introduced into the pinion gear lubricating oil grooves from the second oil introduction channel through the second inner surface oil grooves, the first inner surface oil grooves function as the discharge channels.

In addition to any one of the first to third feature, the present invention has a sixth feature in which the differential case is formed as an integral body including an inner surface having a spherical shape and windows to allow the side gears and the two or more pinion gears to be assembled into the differential case therethrough. The inner surface oil grooves and the pinion gear lubricating oil grooves are formed into one continuous line of groove along a circular arc about a specific axial line passing through a spherical surface center of the inner surface and the at least one window of the windows.

In addition to the sixth feature, the present invention has a seventh feature in which an outer circumferential part of the differential case is provided with a flange part to fix a ring gear thereto such that the flange part and one sides of the windows are aligned in a direction along the first axial line. The flange part protrudes from the outer circumferential part of the differential case. The specific axial line is tilted with respect to the first axial line, as viewed in a projection plane orthogonal to the second axial line, such that the specific axial line is gradually distanced from the flange part as being distanced from the first axial line in an area closer to the one window, with respect to the first axial line, that enables a cutting tool to be put in or taken out.

In addition to the sixth or seventh feature, the present invention has an eighth feature in which the discharge channels are formed into grooves provided in the inner surface of the differential case, and are formed into one continuous line of groove including the inner surface oil grooves and the pinion gear lubricating oil grooves along a circular arc about the specific axial line.

### Effects of the Invention

According to the first feature of the present invention, the inner surface of the differential case comprises: the pinion gear support surfaces; the inner surface oil grooves, each of which is provided in the inner surface at a position outward of a corresponding one of the pinion gear support surfaces and communicating with a corresponding one of the oil introduction channels of the differential case; the pinion gear lubricating oil grooves provided in the respective pinion gear support surfaces, each pinion gear lubricating oil groove including one end opened to a corresponding one of the inner surface oil grooves; and discharge channels, each of which makes another end of the corresponding one of the pinion gear lubricating oil grooves communicate with an internal space of the differential case. Thus, upon reaching the pinion gear lubricating oil grooves from the outside of the differential case through the oil introduction channels and the inner surface oil grooves, the oil flows through this oil grooves and is smoothly discharged into the internal space of the differential case through the discharge channels. That is, the oil and the air are not easily stagnated inside the pinion gear lubricating oil grooves. This encourages fresh supply of the oil and/or replacement with fresh oil into the pinion gear lubricating oil grooves. As a result, the fresh oil easily flows toward the pinion gear support surfaces, thereby enabling sufficient lubrication and cooling of the back sides of the pinion gears.

Furthermore, the oil from the pinion gear lubricating oil groove can be applied to a surface of the back side of each pinion gear facing the pinion gear lubricating oil groove. The surface facing the pinion gear lubricating oil groove is shifted as the pinion gear rotates relative to the pinion gear support surface. Thus, the range of area of the back side of the pinion gear where the oil can be applied follows a rotation trajectory, that is, a circular range, of the surface facing the pinion gear lubricating oil groove with respect to the pinion gear support surface. This circular range over which the oil can be applied has a width increasing in a radial direction as a position of an intermediate part of the pinion gear lubricating oil groove to pass through the pinion gear support surface is located radially inward of the pinion gear support surface. According to the second feature, each pinion gear lubricating oil groove passes through a radially-inward specific area (that is, located radially inward) in a corresponding one of the pinion gear support surfaces that is positioned radially inward of an imaginary circle bisecting a radial width of the corresponding one of the pinion gear support surfaces. This can increase the circular range of the back side of the pinion gear where the oil can be applied, thereby further enhancing efficiency of lubrication and cooling for the pinion gear support surfaces and the back sides of the pinion gears.

Still further, according to the third feature, each pinion gear lubricating oil groove is formed so as to linearly extend as viewed in a projection plane orthogonal to the second axial line (that is, a rotation axial line of the pinion gears). Moreover, the pinion gear lubricating oil groove intersects an imaginary straight line orthogonal to the first axial line (that is, a rotation axial line of) and the second axial line. This simplifies structures and channels of the pinion gear lubricating oil groove, thereby enabling grooving of the pinion gear lubricating oil grooves to be performed relatively easily.

Still further, according to the fourth feature, the differential case includes the boss pats in pairs fitted with and supporting the respective output shafts in pairs so as to make the respective output shafts freely rotatable. The boss parts include inner circumferential surfaces provide with the respective oil introduction channels. The first inner surface oil grooves communicating with the first oil introduction channel, the first pinion gear lubricating oil grooves communicating with the respective first inner surface oil grooves, and the first discharge channels communicating with the respective first pinion gear lubricating oil grooves are included in the first channels. Furthermore, the second inner surface oil grooves communicating with the second oil introduction channel, the second pinion gear lubricating oil groove communicating with the respective second inner surface oil grooves, and the second discharge channel communicating with the second pinion gear lubricating oil groove are included in the second channel. The first channels and the second channel are arranged in the inner surface of the differential case independently from each other. Thus, when the oil is introduced simultaneously into the pinion gear lubricating oil grooves from the oil introduction channels in the inner circumferential surfaces of the boss parts in pairs, combinations of the pinion gear lubricating oil grooves and the discharge channels are arranged independently from each other (that is, arranged for the respective first channels and the second channel). This smooths flow of the oil through the first pinion gear lubricating oil grooves provided to the first channels and flow of the oil through the second pinion gear lubricating oil groove provided to the second channel without interfering with each other, and thus allows discharge of these oils into the differential case from the respective discharge channels. Accordingly, efficiency of lubrication and cooling for the back sides of the pinion gears can be further improved.

According to the fifth feature, the inner surface oil grooves communicating with the first oil introduction channel and the second inner surface oil grooves communicating with the second oil introduction channel are provided in the inner surface of the differential case so as to communicate with each other through the respective pinion gear lubricating oil grooves. When the lubricating oil is introduced into the pinion gear lubricating oil grooves from the first oil introduction channel through the first inner surface oil grooves, the second inner surface oil grooves function as the discharge channels. When the lubricating oil is introduced into the pinion gear lubricating oil grooves from the second oil introduction channel through the second inner surface oil grooves, the first inner surface oil grooves function as the discharge channels. Thus, the inner surface oil grooves on one side can be also utilized as the discharge channels on the other side, which achieves simplification of the entire oil channel structure. There may be a case where there is a difference between an amount of the oil flowing toward the pinion gear lubricating oil grooves from the first oil introduction channel and an amount of the oil flowing toward the pinion gear lubricating oil grooves from the second oil introduction channel. In this case, the oil from one of the first or second oil introduction channel having a greater oil amount can be utilized to lubricate the pinion gear support surfaces without difficulty.

Still further, according to the sixth feature, the differential case is formed as an integral body including an inner surface having a spherical shape and windows to allow the side gears and the two or more pinion gears to be assembled into the differential case therethrough. The inner surface oil grooves and the pinion gear oil grooves are formed into one continuous line of groove along a circular arc about a specific axial line passing through a spherical surface center of the inner surface and at least one window of the windows. Thus, the inner surface oil grooves and the pinion gear lubricating oil grooves, which are one continuous line of groove, can be easily formed through the at least one window provided to the differential case (that is, by utilizing the at least one window for putting in or taking out a cutting tool for working). Accordingly, this improves workability of the inner surface oil grooves and the pinion gear lubricating oil grooves.

Still further, according to the seventh feature, an outer circumferential part of the differential case closer to the one window is provided with a flange part to fix a ring gear thereto. The flange part protrudes from the outer circumferential part of the differential case in a direction along the first axial line. The specific axial line is tilted with respect to the first axial line, as viewed in a projection plane orthogonal to the second axial line, such that the specific axial line is gradually distanced from the flange part as being distanced from the first axial line in an area closer to the one window, with respect to the first axial line, that enables a cutting tool to be put in or taken out. Thus, when the cutting tool is put in or taken out of the differential case through the one window, the cutting tool and the flange part can be easily prevented from interfering with each other. This further improves the workability.

Still further, according to the eighth feature, the discharge channels are formed such that the inner surface of the differential case is recessed into grooves, and are formed into one continuous line of groove including the inner surface oil grooves and the pinion gear lubricating oil grooves along a circular arc about the specific axial line. Thus, the discharge channels, as well as the inner surface oil grooves and the pinion gear lubricating oil grooves, can be worked into one continuous line of grooves along the circular arc, which further improves workability.

### BRIEF DESCRIPTION OF THE DRAWINGS

FIG. 1 is a vertical sectional view (sectional view along a line 1-1 in FIG. 2) illustrating a differential device according to a first embodiment of the present invention and its auxiliary devices.

FIG. 2 is a sectional view along a line 2-2 in FIG. 1, in which illustration of a differential mechanism and output shafts are omitted.

FIG. 3 is a sectional view along a line 3-3 in FIG. 2.

FIG. 4 is a sectional view (sectional view along a line 4-4 in FIG. 2) illustrating a main part of a differential case that is cut along oil grooves in case inner surfaces of the differential case.

FIG. 5 is a partially cutaway perspective view (perspective view when viewed in a direction of an arrow 5 in FIG. 2) showing the main part of the differential case.

FIG. 6A is a schematic diagram, corresponding to FIG. 2, that shows the inner surface of the differential case in the first embodiment.

FIG. 6B is a schematic diagram, corresponding to FIG. 2, that shows the inner surface of the differential case in a first modified example of the first embodiment.

FIG. 6C is a schematic diagram, corresponding to FIG. 2, that shows the inner surface of the differential case in a second modified example of the first embodiment.

FIG. 7D is a schematic diagram, corresponding to FIG. 2, that shows the inner surface of the differential case in a different embodiment from the first embodiment, which corresponds to a third modified example of the first embodiment.

FIG. 7E is a schematic diagram, corresponding to FIG. 2, that shows the inner surface of the differential case in a different embodiment from the first embodiment, which corresponds to a fourth modified example of the first embodiment.

FIG. 7F is a schematic diagram, corresponding to FIG. 2, that shows the inner surface of the differential case in a different embodiment from the first embodiment, which corresponds to a fifth modified example of the first embodiment.

FIG. 7G is a schematic diagram, corresponding to FIG. 2, that shows the inner surface of the differential case in a different embodiment from the first embodiment, which corresponds to a sixth modified example of the first embodiment.

FIG. 8 is a vertical sectional view (sectional view along a line 8-8 in FIG. 9) illustrating a differential device according to a second embodiment and its auxiliary devices.

FIG. 9 a sectional view along lines 9-9 in FIGS. 8 and 10, in which illustration of a differential mechanism and output shafts are omitted.

FIG. 10 is a sectional view along a line 10-10 in FIG. 9.

FIG. 11 is a sectional view (sectional view along a line 11-11 in FIG. 9) illustrating a main part of a differential case that is cut along oil grooves in case inner surfaces of the differential case.

FIG. 12 is a sectional view, corresponding to FIG. 9, that shows a modified example of the second embodiment.

### EXPLANATION OF REFERENCE NUMERALS

A . . . radially-inward specific area of pinion gear support surface, C . . . differential case, Ci . . . inner surface of differential case, Cb1, Cb2 . . . bearing boss parts as boss parts, Cf . . . flange part, Cx . . . spherical surface center, D . . . differential device, Gp, Gp′ . . . pinion gear lubricating oil grooves, Gi . . . inner surface oil groove, Gi1, Gi2 . . . inner surface oil grooves or first and second inner surface oil grooves as first and second inner surface oil grooves, L1, L2 . . . first and second channels, O, O1, O2 . . . discharge channels, P1, P2 . . . first and second pinion gear support surfaces as pinion gear support surfaces, S1, S2 . . . first and second side gear support surfaces as side gear support surfaces, R . . . ring gear, T . . . cutting tool, w . . . width in radial direction of pinion gear support surface, X1, X2 . . . first and second axial lines, X3 . . . imaginary straight line, specific axial line, X3′ . . . specific axial line, Z . . . imaginary circle, 11, 12 . . . output shafts, 15, 16 . . . helical grooves as oil introduction channels, 17 . . . internal space, 18 . . . window, 22 . . . pinion gear, 23 . . . side gear, 30 . . . clearance as oil introduction channel

### MODE FOR CARRYING OUT THE INVENTION

Hereinafter, an embodiment of the present invention is described based on the accompanying drawings.

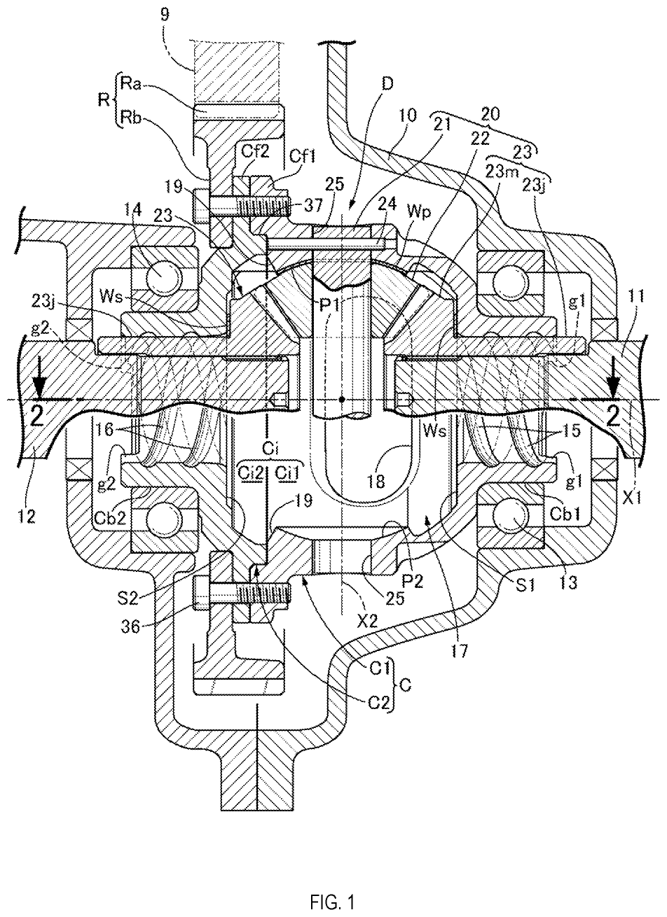

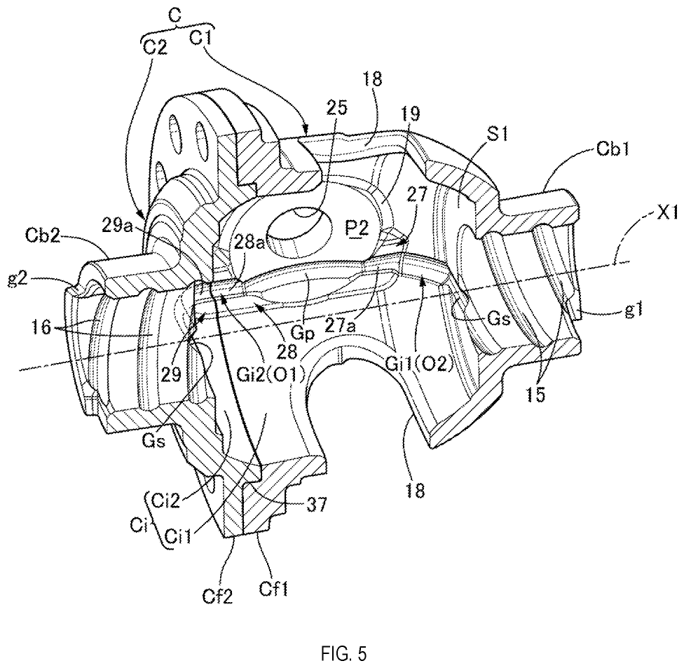

First, reference is made to FIGS. 1 to 5 to describe a first embodiment. In FIG. 1, a transmission case 10 of a vehicle (for example, an automobile) houses a differential device D configured to divide and transmit a power from a not shown power source (for example, an engine installed in a vehicle, a motor, and the like) to an output shaft 11 and an output shaft 12 that are paired as left and right output shafts. The differential device D comprises a differential case C and a differential mechanism 20 to be built in the differential case C. The left and right output shafts 11, 12, respectively, are interlocked with and coupled to left and right drive wheels (not shown).

The differential case C has a configuration divided into and comprises a first half case body C1 having a substantially bowl shape and a second half case body C2 having a lid shape to close an open end of the first half case body C1. The first half and second half case bodies C1, C2, respectively include a flange part Cf1 and a flange part Cf2 provided continuously to outer peripheries of the first half and second half case bodies C1, C2. These flange parts Cf1 and Cf2 are laid over and detachably coupled to an inner circumferential flange part Rb of a ring gear R with two or more bolts 36. The first half and second half case bodies C1, C2 have respective facing surfaces provided with concave and convex engagement portions 37 to be coaxially engaged with each other.

The ring gear R includes gear teeth Ra to be engaged with, for example, a drive gear 9, which acts as an output part of a transmission device connected to a power source. This results in transmission of a rotational driving force from the power source to the differential case C via the ring gear R. The ring gear R may be a helical gear or a spur gear.

There is defined, between the first half and second half case bodies C1, C2, an internal space 17 configured to function as a mechanism chamber to house the differential mechanism 20 therein. In particular, the first half case body C1 is provided with, in its body part, windows 18 in pairs that allow an inside and an outside of the differential case C to communicate with each other and are formed so as to face each other across a first axial line X1. These windows 18 can not only function as inlet and outlet ports for oil, but also function as working windows to allow a cutting tool, a jig, a finger, or the like to be put in or taken out when an inner surface Ci of the differential case C is machined or the differential mechanism 20 is assembled to the differential case C.

The first half case body C1 has an axially-outer part provided with, as a part integral therewith, a first bearing boss Cb1. The second half case body C2 has an axially-outer part provided with, as a part integral therewith, a second bearing boss Cb2. The first and second bearing bosses Cb1, Cb2 are oriented in opposite directions opposite to each other and have cylindrical shapes extending coaxially. The first and second bearing bosses Cb1, Cb2 are one example of the boss parts. The first and second bearing bosses Cb1, Cb2 are supported, on outer peripheries thereof, by the transmission case 10 via a bearing 13 and a bearing 14, respectively, in a freely rotatable manner about the first axial line X1.

Each of the first and second bearing bosses Cb1, Cb2 has an inner circumferential surface where a corresponding one of the left and right output shafts 11, 12 is fitted in and supported in a freely rotatable manner via a hollow shaft part 23j of each side gear 23 to be described later. Furthermore, the first and second bearing bosses Cb1, Cb2, respectively, are provided with one or more lines (two lines in the embodiment) of helical grooves 15, 16 (see, FIG. 1) for drawing lubricating oil therein. The helical groove 15 of the first bearing boss Cb1 and the helical groove 16 of the second bearing boss Cb2 have helical directions opposite to each other.

During the automobile turning forwards, as the differential mechanism 20 rotates at different speeds, the first and second bearing bosses Cb1, Cb2 and the respective hollow shaft parts 23j of the side gears 23 on the left and right sides rotate with respect to each other. In response to this, the helical grooves 15, 16, which are one example of the oil introduction channels, can exhibit a pumping action to deliver the lubricating oil from outside of the differential case C to the inner surface Ci of the differential case C (particularly, side gear support surfaces S1, S2 to be described later). At respective outer ends, the first and second bearing bosses Cb1, Cb2, respectively, are provided with guide protrusions g1, g2 configured to enable guiding of the lubricating oil that scatters and flows down around the differential case C of the transmission case 10 to upstream ends of the helical grooves 15, 16.

The differential mechanism 20 comprises: a pinion shaft 21 arranged in a center part of the differential case C along a second axial line X2 orthogonal to the first axial line X1 and supported by the differential case C; pinion gears 22, 22 in pairs fitted to and supported by the pinion shaft 21 in a freely rotatable manner to the pinion shaft 21; and the side gears 23, 23 in pairs to mesh with the respective pinion gears 22, 22 and to be supported by the differential case C in a freely rotatable manner about the first axial line X1.

The pinion shaft 21 in the present embodiment is fitted to, at both ends thereof, pinion shaft support holes 25 provided in the body part of the first half case body C1. Furthermore, the pinion shaft 21 is fixed to the differential case C with a fixing pin 24 that is inserted in the body part. The way to fix the pinion shaft 21 is not limited to the present embodiment, and various fixing ways (for example, clamping, screwing, and the like) may be employed.

The side gears 23, 23 in pairs function as output gears of the differential mechanism 20. These side gears 23, 23 have respective inner circumferential parts, which are in spline engagement with inner ends of the output shafts 11, 12 in pairs.

Each side gear 23 includes: a side gear main body 23m including teeth and having a large diameter; and a hollow shaft part 23j protruding at a center in a back side of the side gear main body 23m as a piece integral with the side gear main body 23m. The back side of one side gear 23 is supported in a rotatable and slidable manner, via a side gear washer Ws, by a first side gear support surface S1 of an inner surface Ci1 of the first half case body C1. The first side gear support surface S1 is continuous to an inner end of the first bearing boss Cb1. The back side of the other side gear 23 is supported in a rotatable and slidable manner, via the side gear washer Ws, by a second side gear support surface S2 of an inner surface Ci2 of the second half case body C2. The second side gear support surface S2 is continuous to an inner end of the second bearing boss Cb2.

The side gear washer Ws may be omitted. In this case, the respective back sides of the side gears 23 are directly supported by the first and second side gear support surfaces S1, S2 in a rotatable and slidable manner.

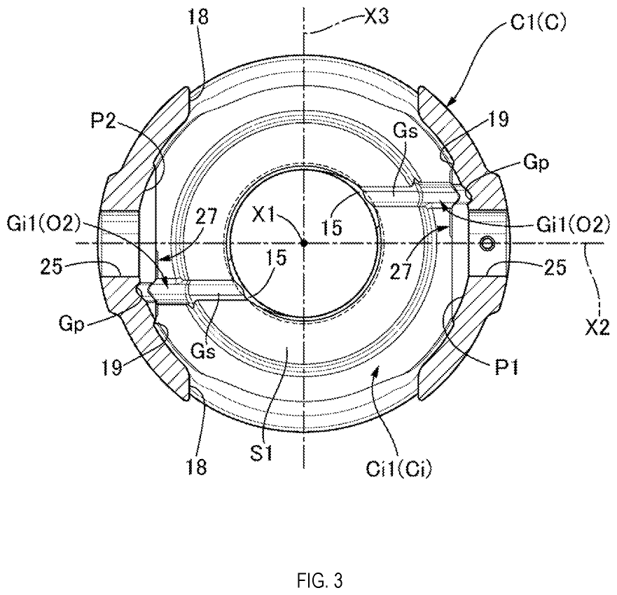

Each of the first and second side gear support surfaces S1, S2 is provided with side gear lubricating oil grooves Gs in pairs, and recessed in a manner to cross a corresponding one of the first and second side gear support surfaces S1, S2. The side gear lubricating oil grooves Gs communicate with downstream ends of the respective helical grooves 15, 16. In each of the side gear support surfaces S1, S2 in the present embodiment, the side gear lubricating oil grooves Gs in pairs are arranged to have a point symmetry with respect to the first axial line X1 as is clear from FIG. 3. However, the arrangement of the side gear lubricating oil grooves is not limited to the embodiment, and can be freely set.

Although each of the side gear support surfaces S1, S2 in the present embodiment is formed in a planar surface orthogonal to the first axial line X1, each side gear support surface S1, S2 may be formed in a part of a tapered surface or a part of a spherical surface in place of the planar surface.

Furthermore, each pinion gear 22 has a back side supported by a corresponding one of support bases 19 in pairs that is provided to the inner surface Ci1 of the first half case body C1 in a manner to protrude concentrically to the pinion shaft 21. The support bases 19 are arranged to face each other on the second axial line X2. Specifically, top surfaces of the support bases 19, which face each other, are formed into concave surfaces having spherical shapes, and form a first pinion gear support surface P1 and a second pinion gear support surface P2 to support the pinion gears. The back side of the pinion gear 22 abuts and is supported by a corresponding one of the pinion gear support surfaces P1, P2 via a pinion gear washer Wp in a rotatable and slidable manner.

The pinion gear washer Wp may be omitted. In this case, the back side of the pinion gear 22 is directly supported by the corresponding one of the first and second pinion gear support surfaces P1, P2 in a rotatable and slidable manner.

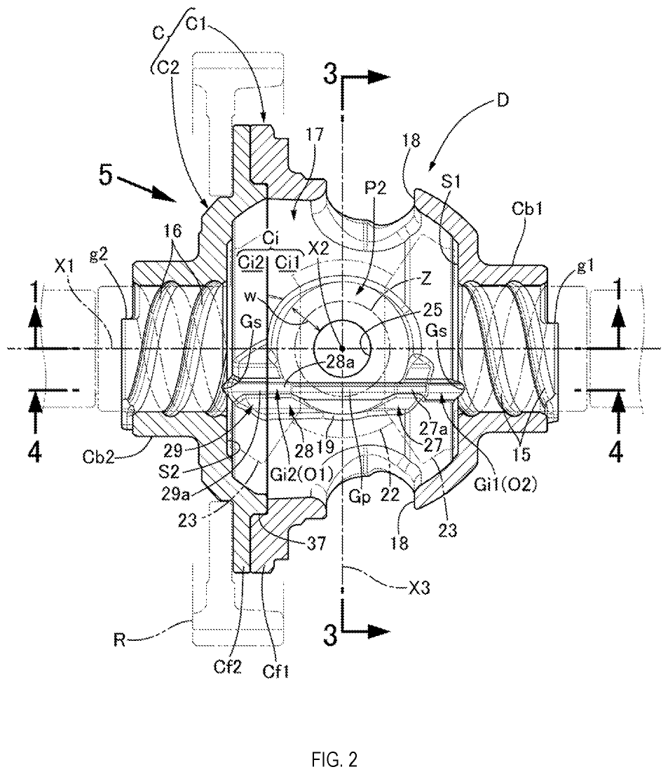

As viewed in a projection plane (see, FIG. 2) orthogonal to the second axial line X2, each of the first and second pinion gear support surfaces P1, P2 is provided with a line of a pinion gear lubricating oil groove Gp linearly extending in parallel to the first axial line X1. As viewed in a projection plane (see, FIG. 3) orthogonal to the first axial line X1, the pinion gear lubricating oil grooves Gp are formed at respective positions corresponding to the side gear lubricating oil grooves Gs, Gs paired and provided in each of the first and second side gear support surfaces S1, S2.

In the embodiment, each of the first and second pinion gear support surfaces P1, P2 is illustrated as a concave surface having a spherical shape by way of example. However, each pinion gear support surface may be a tapered surface or a planar surface orthogonal to the second axial line X2.

As is clear from FIGS. 2 to 5, the inner surface Ci of the differential case C is provided with, at positions outward of the respective support bases 19, first inner surface oil grooves Gi1 in pairs and second inner surface oil grooves Gi2 in pairs. The first inner surface oil grooves Gi1 have one ends communicating with the respective side gear lubricating oil grooves Gs in pairs in the first side gear support surface S1, and the second inner surface oil grooves Gi2 have one ends communicating with the side gear lubricating oil grooves Gs in pairs in the second side gear support surface S2. Furthermore, one ends of the respective pinion gear lubricating oil grooves Gp in the first and second pinion gear support surfaces P1, P2 are opened to the respective other ends of the first inner surface oil grooves Gi1 in pairs. Still further, the other ends of the respective pinion gear lubricating oil grooves Gp in the first and second pinion gear support surfaces P1, P2 are opened to the respective other ends of the second inner surface oil grooves Gi2 in pairs.

Accordingly, the first inner surface oil grooves Gi1 in pairs communicating with the helical groove 15 in the first bearing boss Cb1 and the second inner surface oil grooves Gi2 in pairs communicating with the helical groove 16 in the second bearing boss Cb2 communicate with each other through the lines of the pinion gear lubricating oil grooves Gp provided in the respective first and second pinion gear support surfaces P1, P2.

When, for example, the lubricating oil is introduced into the pinion gear lubricating oil grooves Gp from the helical groove 15 on one side through the first inner surface oil grooves Gi1, the second inner surface oil grooves Gi2 function as discharge channels O1 to discharge oil inside the pinion gear lubricating oil grooves Gp to the internal space 17 of the differential case C. When the lubricating oil is introduced into the pinion gear lubricating oil grooves Gp from the helical groove 16 on the other side through the second inner surface oil grooves Gi2, the first inner surface oil grooves Gi1 function as discharge channels O2 to discharge the oil inside the pinion gear lubricating oil grooves Gp to the internal space of the differential case C.

In the present embodiment, as is clear from FIG. 2, each of the pinion gear lubricating oil grooves Gp is arranged so as to pass through a radially-inward specific area A of a corresponding one of the pinion gear support surfaces P1, P2. The radially-inward specific area A is positioned radially inward of an imaginary circle Z that bisects a radial width w of the corresponding one of the pinion gear support surfaces P1, P2. In the present embodiment, the pinion gear lubricating oil groove Gp is illustrated such that a part (most part) in a groove-width direction thereof passes through the radially-inward specific area A. However, the entirety in the groove-width direction of the pinion gear lubricating oil groove Gp may pass through the radially-inward specific area A.

As discussed above, the pinion gear lubricating oil groove Gp is formed so as to linearly extend as viewed in the projection plane (see, FIG. 2) orthogonal to the second axial line X2. Furthermore, as viewed in the projection plane (see, FIG. 2), the pinion gear lubricating oil groove Gp intersects (particularly, in the embodiment, orthogonal to) an imaginary straight line X3 orthogonal to the first and second axial lines X1, X2.

Each of the first and second pinion gear support surfaces P1, P2 in the present embodiment is formed in the top surface of a corresponding one of the support bases 19 provided in pairs to the inner surface Ci of the differential case C in a protruding manner. Thus, there is a difference in height between each of the pinion gear support surfaces P1, P2 and the inner surface Ci of the differential case C.

To address this difference in height, the inner surface Ci1 of the first half case body C1 is provided with, as a piece integral therewith, a protruding wall part 27 that is continuous to each support base 19 and is gradually decreased toward the inner surface Ci1. The protruding wall part 27 is provided with a groove part 27a that is a part of the first inner surface oil grooves Gi1. Thus, the first inner surface oil grooves Gi1 can be connected as smoothly as possible to the respective pinion gear lubricating oil grooves Gp in the first and second pinion gear support surfaces P1, P2 even in a case where there is the above-described difference in height.

The inner surface Ci1 of the first half case body C1 and the inner surface Ci2 of the second half case body C2, respectively, are provided with, as pieces integral therewith, protruding wall parts 28, 29 that connect circumferential surfaces of the respective support bases 19 to an inner end surface of the second half case body C2. These protruding wall parts 28, 29, respectively, are provided with groove parts 28a, 29a, each of which is a part of a corresponding one of the second inner surface oil grooves Gi2. Thus, the second inner surface oil grooves Gi2 can be connected as smoothly as possible to the respective pinion gear lubricating oil grooves Gp in the first and second pinion gear support surfaces P1, P2 even in a case where there is the above-described difference in height.

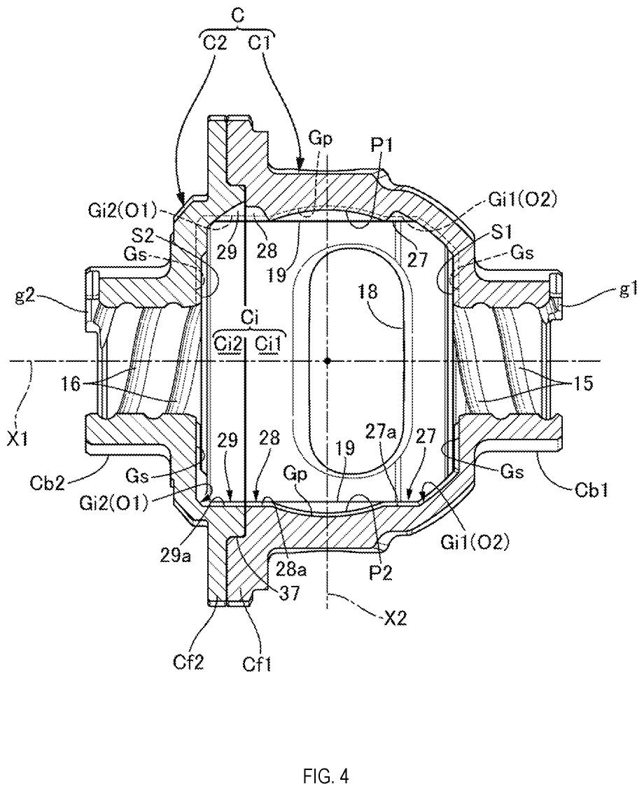

As is clear from FIG. 4, in the present embodiment, oil flow channels extending from the helical grooves 15, 16 to the pinion gear lubricating oil grooves Gp through the inner surface oil grooves Gi1, Gi2 are designed so as to have a distance gradually increasing from the axial line X1 in a radial direction relative to the first axial line X1 as a central axial line. In this design, there is no possibility that the lubricating oil introduced from the helical grooves 15, 16 is discouraged to flow due to an obstacle and/or an upward gradient until reaching the pinion gear lubricating oil grooves Gp through the inner surface oil grooves Gi1, Gi2 under a centrifugal force. Thus, the lubricating oil smoothly flows from the helical grooves 15, 16 to the pinion gear lubricating oil grooves Gp.

A description is given to an effect of the first embodiment. During traveling of an automobile into which the differential device D of the present embodiment is assembled, a rotation driving force from the power source is transmitted from the ring gear R to the differential case C. Then, the rotation driving force is divided and transmitted to the left and right output shafts 11, 12 via the differential mechanism 20 of the differential device D with the differential mechanism 20 being allowed to rotate at different speeds. In this case, the differential mechanism 20 does not rotate at different speeds during the automobile travelling straight. Specifically, the first and second bearing bosses Cb1, Cb2 of the differential case C and the left and right side gears 23 (that is, the output shafts 11, 12) rotate forwardly, not rotate relative to each other, respectively.

In contrast, during the automobile making a turn, the first and second bearing bosses Cb1, Cb2 and the left and right side gears 23 rotate relative to each other, respectively, as the differential mechanism 20 rotates at different speeds due to differences in turning radius of left and right drive wheels. As a result of this relative rotation, the helical grooves 15, 16 can exhibit the pumping action. Thus, the oil introduced from the outside of the differential case C (particularly, near an outer end of each of the bearing bosses Cb1, Cb2) into the helical grooves 15, 16 with the guide protrusions g1, g2 flows to the first and second side gear support surfaces S1, S2 inside the differential case C through the helical grooves 15, 16. Specifically, the oil flows into the side gear lubricating oil grooves Gs to thereby lubricate the first and second side gear support surfaces S1, S2.

Furthermore, the oil that has been released from the side gear lubricating oil grooves Gs in the first and second side gear support surfaces S1, S2 flows through the first and second inner surface oil grooves Gi1, Gi2 toward the pinion gear lubricating oil grooves Gp to thereby lubricate the pinion gear support surfaces P1, P2. In this case, during the differential mechanism 20 rotating at different speeds, there may be a difference between an amount of oil from the helical groove 15 (16) on one of the left or right side to the pinion gear lubricating oil grooves Gp through the side gear lubricating oil grooves Gs and an amount of oil from the helical groove 16 (15) on the other of the left or right side to the pinion gear lubricating oil grooves Gp through the side gear lubricating oil grooves Gs.

For example, during the automobile making a right turn, the amount of oil from the helical groove 15 on the right side to the pinion gear lubricating oil grooves Gp is greater than the amount of oil from the helical groove 16 on the left side to the pinion gear lubricating oil grooves Gp. As a result, the oil flowing into the pinion gear lubricating oil grooves Gp from the right side, where a greater amount of oil is present, flows through the pinion gear lubricating oil grooves Gp against a flow of the oil from the opposite side (left side). Then, the oil that has passed through the pinion gear lubricating oil grooves Gp is discharged into the internal space 17 of the differential case C through the second inner surface oil grooves Gi2 on the left side. In other words, in this case, the second inner surface oil grooves Gi2 on the left side function as the discharge channels O1 to discharge the oil released from the pinion gear lubricating oil grooves Gp into the differential case C.

Furthermore, even in a case where the differential mechanism 20 does not rotate at different speeds (that is, the first and second bearing bosses Cb1, Cb2 and the left and right side gears 23 do not rotate relative to each other, respectively), a guiding effect and the like of the guide protrusions g1, g2 may cause some oil to flow, in the same amount, from the left and right helical grooves 15, 16 into each pinion gear lubricating oil groove Gp, causing the oil to collide with each other at an intermediate part of the pinion gear lubricating oil groove Gp (that is, the oil is stagnant in the pinion gear lubricating oil groove Gp). In this case, however, the pinion gear support surfaces P1, P2 and the back sides of the pinion gears 22 do not rotatably slide on each other, thus not requiring sufficient lubrication. Accordingly, stagnation of the oil does not cause particular disadvantage.

As described above, in the differential device D in the present embodiment, as the differential mechanism 20 rotates at different speeds, the oil outside the differential case C flows from the helical groove 15 (16) on one of the left or right side to the pinion gear lubricating oil grooves Gp through the inner surface oil grooves Gi1 (Gi2) on one of the left or right side. Then, the oil flows through these pinion gear lubricating oil grooves Gp and is smoothly discharged to the internal space 17 of the differential case C through the inner surface oil grooves Gi2 (Gi1) on the other of the left or right side, that is, discharge channels O1 (O2). This inhibits stagnation of the oil and/or the air inside the pinion gear lubricating oil grooves Gp, encouraging fresh supply of the oil and/or replacement with fresh oil into the pinion gear lubricating oil grooves Gp. As a result, the fresh oil easily flows toward the pinion gear support surfaces P1, P2, thereby enabling sufficient lubrication and cooling of the back sides of the pinion gears 22.

When the lubricating oil is introduced into the pinion gear lubricating oil grooves Gp from the helical groove 15 on one of the left or right side through the inner surface oil grooves Gi1 on the same side, the inner surface oil grooves Gi2 on the opposite side function as the discharge channels O1. Furthermore, when the lubricating oil is introduced into the pinion gear lubricating oil grooves Gp from the helical groove 16 on the other of the left or right side through the inner surface oil grooves Gi2 on the same side, the inner surface oil grooves Gi1 on the opposite side function as the discharge channels O2. Thus, there is no need for a discharge channels specialized for discharging, which simplifies a structure of the oil channel as a whole.

The pinion gear lubricating oil grooves Gp in the present embodiment are arranged so as to pass through the radially-inward specific areas A of the pinion gear support surfaces P1, P2 that are positioned radially inward of the imaginary circle Z bisecting the radial widths w of the pinion gear support surfaces P1, P2. Due to the reason detailed as follows, this arrangement can contribute to improvement in efficiency of lubrication and cooling of the pinion gear support surfaces P1, P2 and the back sides of the pinion gears 22.

Specifically, the oil from the pinion gear lubricating oil groove Gp can be applied to a surface of the back side of each pinion gear 22 facing the pinion gear lubricating oil groove Gp. The surface facing the pinion gear lubricating oil groove Gp is shifted as the pinion gear 22 rotates relative to each of the pinion gear support surfaces P1, P2. Thus, the range of area of the back side of the pinion gear 22 where the oil can be applied follows a rotation trajectory, that is, a circular range, of the surface facing the pinion gear lubricating oil groove Gp with respect to the pinion gear support surface. This circular range over which the oil can be applied has a width increasing in a radial direction as a position of an intermediate part of the pinion gear lubricating oil groove Gp to pass through each of the pinion gear support surfaces P1, P2 is located radially inward of each of the pinion gear support surfaces P1, P2. Thus, as discussed above, when the radially-inward specific area A (that is, located radially inwardly) of each of the pinion gear support surfaces P1, P2 is arranged so as to pass through the pinion gear lubricating oil groove Gp, the above-described circular range over which the oil is put on the back side of the pinion gear 22 can be expanded. This can enhance lubricating performance for the pinion gear support surfaces P1, P2, and the back sides of the pinion gears 22.

Furthermore, the pinion gear lubricating oil groove Gp and the inner surface oil grooves Gi1, Gi2 (and thus, the discharge channels O2, O1) in the present embodiment are formed so as to linearly extend as viewed in the projection plane (see, FIG. 2) orthogonal to the second axial line X2. Moreover, the pinion gear lubricating oil grooves Gp intersect the imaginary straight line X3 orthogonal to the first and second axial lines X1, X2. This simplifies structures and channels of the pinon gear lubricating oil grooves Gp and the inner surface oil grooves Gi1, Gi2 as much as possible, thereby enabling grooving to be performed relatively easily. For example, when machining is employed to form a groove, working is easy. When casting or forging is performed to form a groove in a mold, it is easy to form the groove in a mold. The oil flowing into the pinion gear lubricating oil groove Gp passes, while flowing through the pinion gear lubricating oil groove Gp, through a part where a relatively large centrifugal force is to be exerted on the oil. This enhances retainability of the oil in the pinion gear lubricating oil groove Gp, thereby further enhancing efficiency of lubrication and cooling for the back sides of the pinion gears 22.

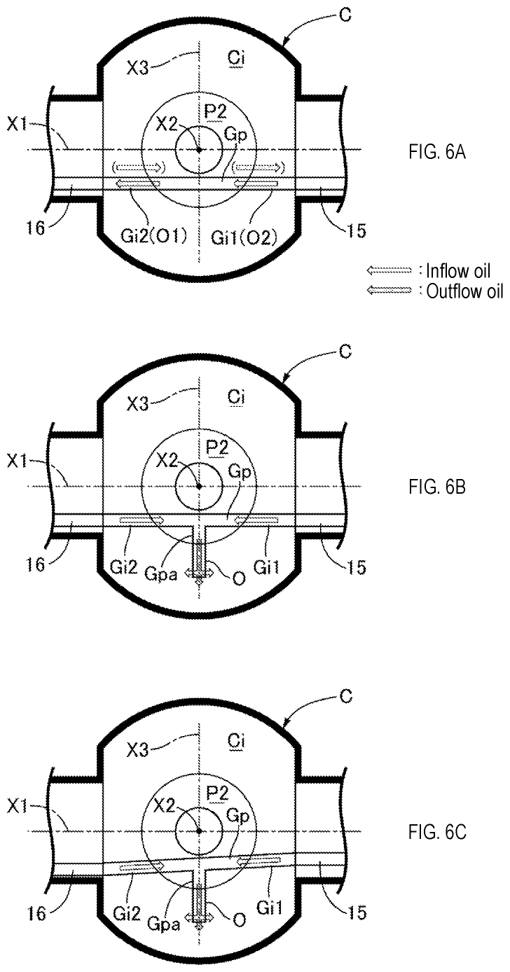

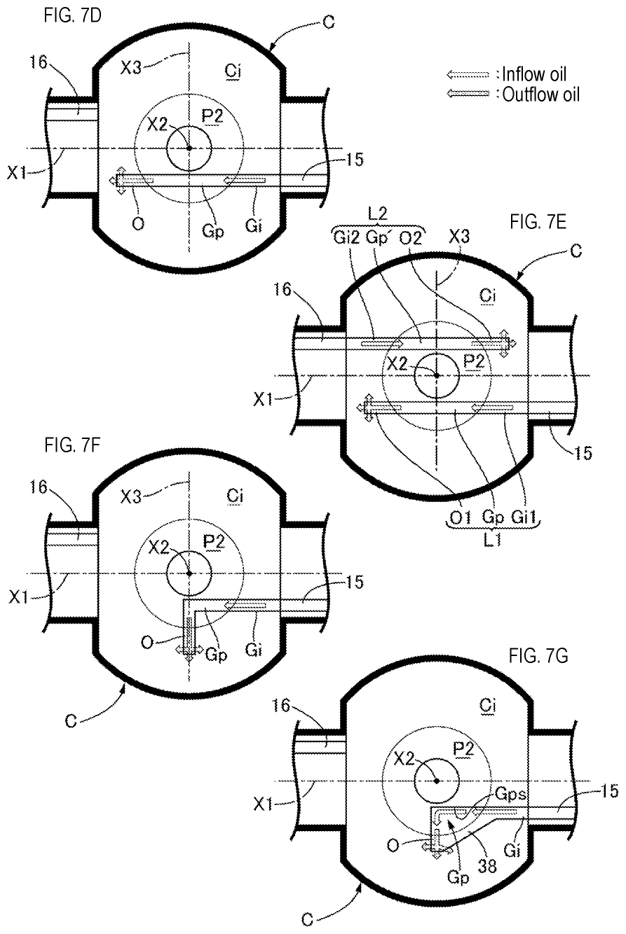

Reference is made to FIGS. 6 and 7 to briefly describe the first embodiment and its modified examples. Specifically, FIG. 6A is a schematic view of the inner surface Ci of the differential case C in the first embodiment as viewed in the same direction as in FIG. 2, whereas FIGS. 6B, (c), and FIGS. 7D to (g), respectively, correspond to first to sixth modified examples of the first embodiment.

In the first embodiment, the first inner surface oil grooves Gi1 communicating with the helical groove 15 on one side and the second inner surface oil grooves Gi2 communicating with the helical groove 16 on the other side communicate with each other through the pinion gear lubricating oil grooves Gp. When the lubricating oil is introduced into the pinion gear lubricating oil grooves Gp from the helical groove 15 on one of the left or right side through the inner surface oil grooves Gi1 on the same side, the inner surface oil grooves Gi2 on the opposite side function as the discharge channels O1. Furthermore, when the lubricating oil is introduced into the pinion gear lubricating oil grooves Gp from the helical groove 16 on the other of the left and right side through the inner surface oil grooves Gi2 on the same side, the inner surface oil grooves Gi1 on the opposite side function as discharge channels O2. In contrast, a first modified example illustrated in FIG. 6B is different only in that the intermediate part of each of the pinion gear lubricating oil grooves Gp has a branch channel Gpa extending therefrom, and an extending part of the branch channel communicates with a dedicated discharge channel O formed into a groove and provided in the inner surface Ci of the differential case C.

Thus, in the first modified example, the oil inside the pinion gear lubricating oil groove Gp can be smoothly discharged through the dedicated discharge channel O even when the oil simultaneously flows into the pinion gear lubricating oil groove Gp in both left and right directions from the left and right helical grooves 15, 16 through the first and second inner surface oil grooves Gi1, Gi2.

In the first embodiment and its first modified example, the pinion gear lubricating oil groove Gp and the inner surface oil grooves Gi1, Gi2 are orthogonal to the imaginary straight line X3 orthogonal to the first and second axial lines X1, X2 as viewed in the projection plane orthogonal to the second axial line X2. In contrast, a second modified example illustrated in FIG. 6C is different only in that the pinion gear lubricating oil groove Gp and the inner surface oil grooves Gi1, Gi2 are diagonal to the imaginary straight line X3 as viewed in the projection plane.

Furthermore, in the first embodiment, the second inner surface oil grooves Gi2 communicate with the helical groove 16 on the other side to thereby also function as the discharge channels O1. In contrast, in a third modified example illustrated in FIG. 7D, each of discharge channels O formed into grooves and corresponding to the second inner surface oil grooves Gi2 terminates adjacent to the second side gear support surface S2, and does not directly communicate with a corresponding one of the side gear lubricating oil grooves Gs in the second side gear support surface S2 and the helical groove 16. That is, the discharge channel O in the third modified example functions as a dedicated discharge channel, and does not function as an inner surface oil groove into which the oil flows from the helical groove 16.

Thus, in the third modified example, the oil flowing into inner surface oil grooves Gi from the helical groove 15 through the side gear lubricating oil grooves Gs in the first side gear support surface S1 flows through the pinion gear lubricating oil grooves Gp, and is thereafter discharged into the internal space 17 of the differential case C through the dedicated discharge channels O.

In a fourth modified example illustrated in FIG. 7E, there is a second pinion gear lubricating oil groove Gp′ added in the second pinion gear support surface P2 in addition to the pinion gear lubricating oil groove Gp in the third modified example. The second pinion gear lubricating oil groove Gp′ includes an inflow part communicating with the second inner surface oil groove Gi2 communicating with the helical groove 16 on the other side. Furthermore, the second pinion gear lubricating oil groove Gp′ includes an outflow part communicating with a dedicated discharge channel O2 formed into a groove. The dedicated discharge channel O2 is provided in the inner surface Ci of the differential case C and terminates adjacent to the first side gear support surface S1.

Thus, in the fourth modified example, there are first channels L1 including the first inner surface oil grooves Gi1 communicating with the helical groove 15 on one of the left or right side, the first pinion gear lubricating oil grooves Gp having inflow parts communicating with the first inner surface oil grooves Gi1, and the first discharge channels O1 communicating with outflow parts of the first pinion gear lubricating oil grooves Gp. Furthermore, there is a second channel L2 including the second inner surface oil groove Gi2 communicating with the helical groove 16 on the other of the left or right side, the second pinion gear lubricating oil groove Gp′ having the inflow part communicating with the second inner surface oil groove Gi2, and the second discharge channel O2 communicating with the outflow part of the second pinion gear lubricating oil groove Gp. The first channels L1 and the second channel L2 are arranged in the inner surface Ci of the differential case C as channels independent from each other. Even when the oil is simultaneously introduced toward the pinion gear lubricating oil grooves Gp, Gp′ from both the left and right helical grooves 15, 16, the oil in the pinion gear lubricating oil grooves Gp and the oil in the pinion gear lubricating oil groove Gp′ smoothly flow without interfering with each other, and can flow back into the differential case C through the dedicated discharge channels O1, O2, respectively. This is because pairs of the pinion gear lubricating oil grooves Gp and the discharge channels O1, and a pair of the pinion gear lubricating oil groove Gp′ and the discharge channel O2 are arranged independent from each other (that is, arranged in the first channels and the second channel, respectively). This can further enhance efficiency of lubrication and cooling for the back sides of the pinion gears 22.

Still further, FIG. 7F illustrates a fifth modified example, which is varied from the third modified example illustrated in FIG. 7D. In the fifth modified example, each pinion gear lubricating oil groove Gp is bent at a certain part thereof. The bent part is provided to the inner surface Ci of the differential case C and communicates with a dedicated discharge channel O that is formed into a groove and spaced apart from the first and second side gear support surfaces S1, S.

The first to fifth modified examples described above illustrate the dedicated discharge channels O, O1, O2 to be formed of grooves provided in the inner surface Ci of the differential case C. However, the dedicated discharge channels O, O1, O2 are not necessarily in the form of grooves. Specifically, the dedicated discharge channels O, O1, O2 may have any oil discharge configuration that can discharge the oil into the internal space 17 through the pinion gear lubricating oil grooves Gp, Gp′ by making at least outlets of the pinion gear lubricating oil grooves Gp, Gp′ communicate with the internal space 17 of the differential case C. For example, although illustration is not provided, in the outer circumferential surfaces of the support bases 19 protruding from the inner surface Ci of the differential case C, the outlets of the pinion gear lubricating oil grooves Gp may be laterally opened so as to directly communicate with the internal space 17 (particularly, a peripheral space of the support bases 19) of the differential case C. In this case, the outlets of the pinion gear lubricating oil grooves Gp and the peripheral space of the support bases 19 with which the outlets communicate form a dedicated discharge channel.

FIG. 7G illustrates a sixth modified example, which is varied from the fifth modified example illustrated in FIG. 7F. In the sixth modified example, the respective pinion gear lubricating oil grooves Gp provided in the pinion gear support surfaces P1, P2 are expanded radially outward. Furthermore, an increased-width groove part 38 is provided so as to make each inner surface oil groove Gi communicate with a corresponding one of the discharge channels O at a position outward of each of the pinion gear support surfaces P1, P2. The increased-width groove part 38 extends in a manner to bypass sides of the pinion gear support surfaces P1, P2. Still further, the pinion gear lubricating oil groove Gp is arranged such that, during the automobile travelling forwards (that is, during the differential case C rotating forwardly about the first axial line X1), an inner surface part Gps thereof adjacent to the first axial line X1 is located in a rear side of the pinion gear lubricating oil groove Gp in a rotation direction of the differential case C, that is, in an upper side of the pinion gear lubricating oil groove Gp in FIG. 7G.

During the differential case C rotating forwardly, the oil inside the pinion gear lubricating oil groove Gp tends to rotate at the same circumferential speed as an oil groove wall surface. However, the circumferential speed of the oil in the oil groove tend to decrease as the circumferential speed of a wall surface of the pinion gear lubricating oil groove Gp gradually increases toward the second axial line X2 in a direction along the first axial line X1. Thus, due to decrease of the circumferential speed of the oil, the oil inside the pinion gear lubricating oil groove Gp flows along the inner surface part Gps while receiving a force to draw the oil toward a wall surface of the inner surface part Gps in the groove. Consequently, the oil inside the pinion gear lubricating oil groove Gp can effectively lubricate the pinon gear support surfaces P1, P2 without any possibility of the oil widely flowing out to the increased-width groove part 38.

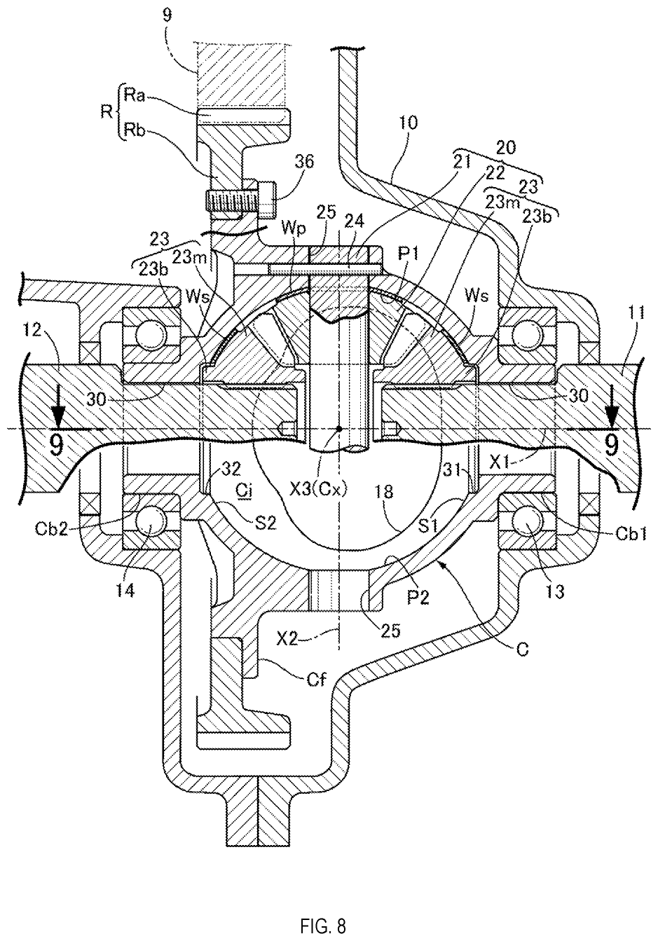

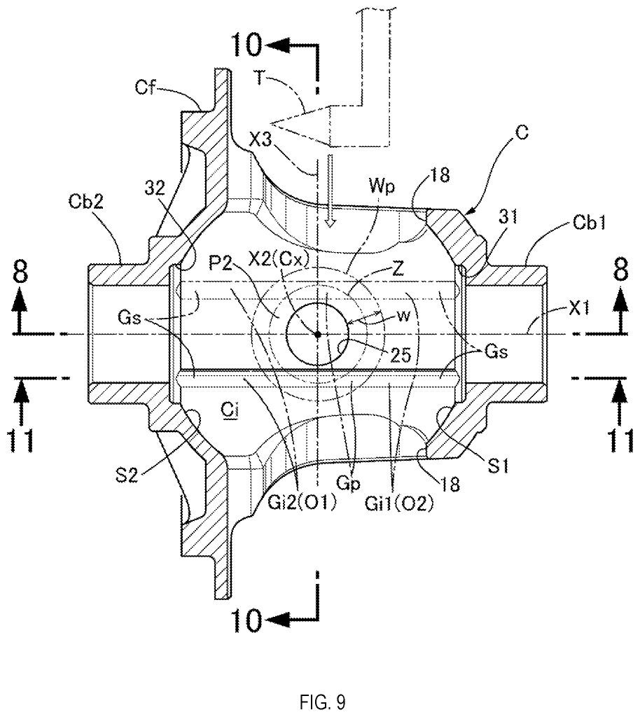

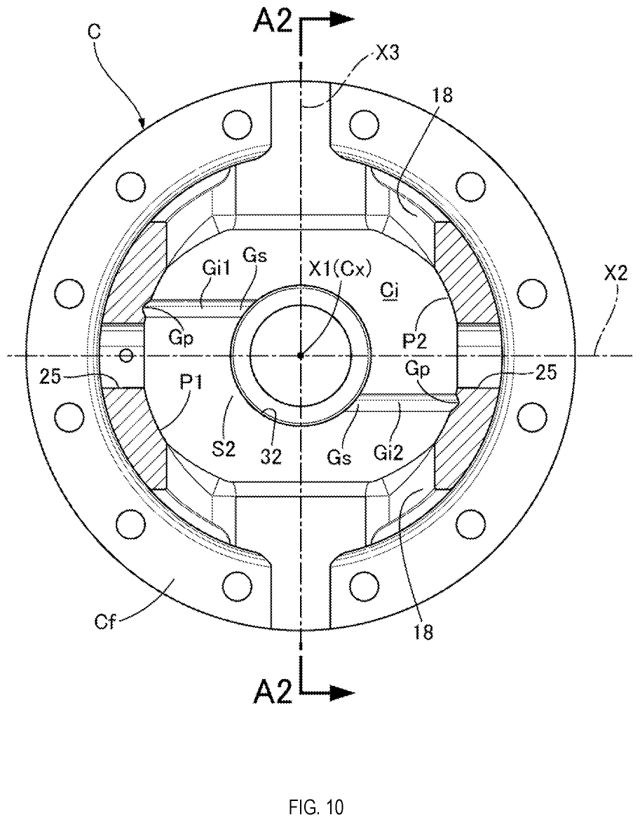

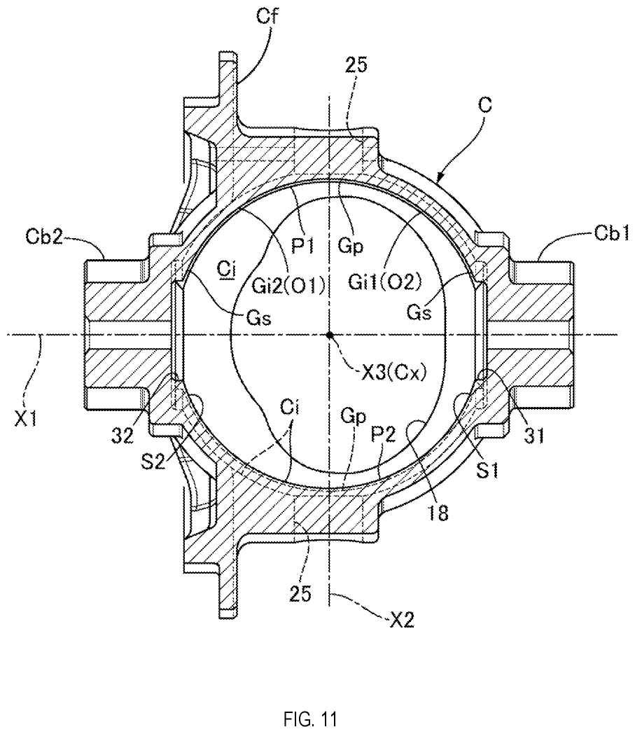

Still further, FIGS. 8 to 11 illustrate a second embodiment of the present invention. In the first embodiment, the differential case C is divided into and comprises the first and second half case bodies C1, C2. In the second embodiment, however, the differential case C is formed into a seamless, integral case including an inner surface Ci formed to have a spherical shape. Furthermore, the differential case C includes a body part provided with large windows 18 in pairs through which the side gears 23 and the pinion gears 22 are assembled into the differential case C. Still further, an outer circumferential part of the differential case C is provided with, as a piece integral therewith, a flange part Cf to fix the ring gear R to the flange part Cf such that the flange part and one sides of the windows 18 are aligned in a direction along the first axial line X1.

Furthermore, each of the left and right side gears 23 integrally includes, in the center in the back side of the side gear main body 23m including the teeth, a boss part 23b having a short length in place of the hollow shaft part 23j (see, the first embodiment) having a long length. The inner surface Ci of the differential case C comprises: annular recesses 31, 32, respectively, continuous to inner circumferential ends of the respective first and second bearing bosses Cb1, Cb2 and receiving the respective boss parts 23b; the side gear support surfaces S1, S2 that have annular and spherical shapes, are continuous to outer circumferential ends of the respective annular recesses 31, 32, and support spherical back sides of the side gears 23 directly or via the side gear washers Ws such that the spherical back sides of the side gears 23 can rotate and slide on the respective side gear support surfaces S1, S2; and the pinion gear support surfaces P1, P2 that have annular and spherical shapes, are continuous to inner open ends of the respective pinion shaft support holes 25, and support spherical back sides of the respective pinion gears 22 directly or via the pinion gear washers Wp such that the spherical back sides of the pinion gears 22 can rotate and slide on the respective pinion gear support surfaces P1, P2.

Still further, the inner circumferential surfaces of the first and second bearing bosses Cb1, Cb2, respectively, are directly fitted with the output shafts 11, 12, with clearances 30 defined in a size large enough to allow the lubricating oil to flow. The clearance 30 is a part of an oil introduction channel that can introduce the lubricating oil groove from the outside of the differential case C to each of the first and second side gear support surfaces S1, S2 (particularly, the side gear lubricating oil grooves Gs). Although illustration is omitted, the first and second bearing bosses Cb1, Cb2 in the second embodiment may be provided with, at respective outer ends, the guide protrusions g1, g2 for guiding the lubricating oil groove, which are the same as those in the first embodiment. Still further, in place of the above-described clearance 30, the first and second bearing bosses Cb1, Cb2 may be provided with, in the respective inner circumferential surfaces, the same oil introduction channels as those in the first embodiment, that is, the helical grooves 15, 16.

Accordingly, the inner surface Ci of the differential case C in the second embodiment is also provided with the same set of oil grooves as that in the first embodiment (that is, the pinion gear lubricating oil grooves Gp, the first and second inner surface oil grooves Gi1, Gi2, and the side gear lubricating oil grooves Gs). The first and second inner surface oil grooves Gi1, Gi2 in the second embodiment can also function as the discharge channels O2, O1, respectively as in the first and second inner surface oil grooves Gi1, Gi2 in the first embodiment.

In the second embodiment, in particular, the pinion gear lubricating oil grooves Gp, the first inner surface oil grooves Gi1 (also functions as the discharge channels O2), the second inner surface oil grooves Gi2 (also function as the discharge channels O1), and the side gear lubricating oil grooves Gs are formed into one continuous line of groove along a circular arc about a specific axial line X3 that passes through a spherical surface center Cx of the inner case Ci of the differential case and at least one window 18. Forming the grooves Gp, Gi1, Gi2, Gs is performed at the same time when the inner surface Ci of the differential case C is processed. For example, a cutting tool T (for example, a bite for turning tool) for machining is used to be moved, along the specific axial line X3 through the window 18, to an inner part of a material for the differential case, which has been formed by casting, forging, or the like, with the material for the differential case rotated about the specific axial line X3.

Other configurations in the second embodiment are basically the same as the first embodiment. Thus, constituent elements in the second embodiment are labelled with the same reference numerals used for the corresponding constituent elements in the first embodiment, and detailed descriptions of configurations of these constituent elements will be omitted. The second embodiment can also achieve effects that are basically the same as in the first embodiment, and additionally, can achieve particular effects as described below.

Specifically, in the second embodiment, in the spherical inner surface Ci of the differential case C formed in an integral manner, the pinion gear lubricating oil grooves Gp, the first and second inner surface oil grooves Gi1, Gi2, and the side gear lubricating oil grooves Gs are formed into the one continuous line of groove along the circular arc about the specific axial line X3 passing through the spherical surface center Cx of the inner surface Ci of the differential case and the at least one window 18. Thus, the inner surface oil grooves Gi1, Gi2 (also function as the discharge channels O2, O1, respectively), the pinion gear lubricating oil grooves Gp, and the side gear lubricating oil grooves Gs can be easily worked into one continuous line of groove through the windows 18 of the differential case C (that is, by using the windows 18 as ports for putting in or taking out the cutting tool T for working). Consequently, workability of the set of oil grooves Gi1, Gi2, Gp, Gs are excellent.

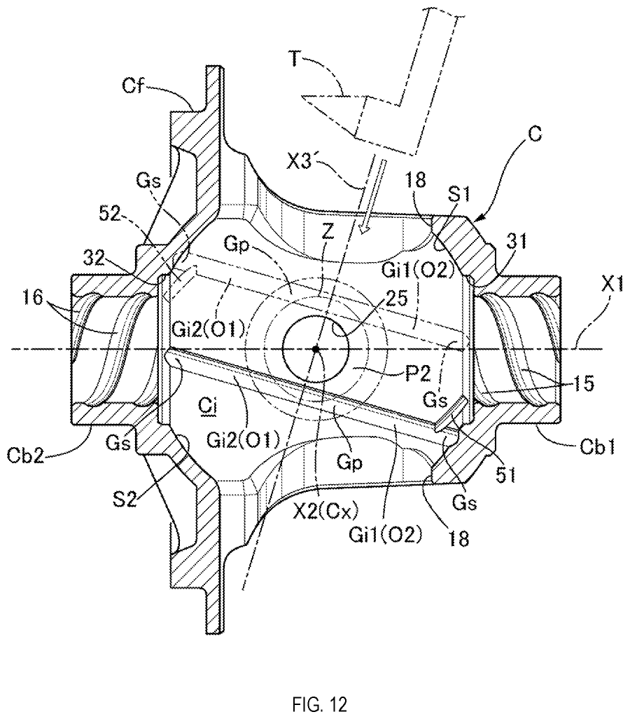

Furthermore, FIG. 12 illustrates a modified example of the second embodiment. In this modified example, on the side where the window 18 for putting in or taking out the cutting tool T is located, the specific axial line X3′ passing through the spherical surface center Cx of the inner surface Ci of the differential case C and the at least one window 18 is tilted with respect to the first axial line X1, as viewed in a projection plane (see, FIG. 12) orthogonal to the second axial line X2, such that the specific axial line X3′ is gradually distanced from the flange part Cf as being distanced from the first axial line X1 in an area closer to the one window, with respect to the first axial line X1, that enables the cutting tool T to be put in or taken out. Thus, the modified example of the second embodiment can exhibit a particular effect to be described as follows as well as the effect of the second embodiment. Specifically, when a molded material for the differential case is machined, in particular, when the cutting tool T is put in or taken out of the molded material for the differential case through the window 18 along the specific axial line X3′ tilted, the cutting tool T and the flange part Cf can be easily prevented from interfering with each other. This further enhances the workability.

Furthermore, as a result of the specific axial line X3′ being tilted in a manner described above, the one continuous line of the inner surface oil grooves Gi1, Gi2, the pinion gear lubricating oil grooves Gp, and the side gear lubricating oil grooves Gs are formed into a straight line tilted with respect to the first axial line X1 as viewed in the projection plane (see, FIG. 12) orthogonal to the second axial line X2. Thus, in this modified example, although one ends of the inner surface oil grooves Gi1, Gi2 are not opened to the annular recesses 31, 32 in the first and second side gear support surfaces S1, S2, communicating grooves S1, S2, respectively, are provided to the inner surface Ci of the differential case C so as to make the one end of the inner surface oil groove Gi1 communicate with the annular recess 31 (that is, the helical groove 15) and make the one end of the inner surface oil groove Gi2 communicate with the annular recess 32 (that is, the helical groove 16).

In the modified example of the second embodiment, the inner circumferential surfaces of the first and second bearing bosses Cb1, Cb2, respectively, are provided with the helical grooves 15, 16 as the oil introduction channels. However, the helical grooves 15, 16 may be replaced. Specifically, as in the second embodiment, the clearances 30, which are relatively large, may be provided to the parts of the first and second bearing bosses Cb1, Cb2 fitted with the output shafts 11, 12, respectively, to thereby form the oil introduction channels. Furthermore, although illustration is omitted, the outer ends of the first and second bearing bosses Cb1, Cb2 in the modified example of the second embodiment may also be provided with the guide protrusions g1, g2, respectively, as in the first embodiment.

Still further, regarding the first embodiment described above, FIGS. 6B, (c), and FIGS. 7D to (g) illustrate various modified examples related to modes of the oil grooves Gp, Gp′, Gi, Gi1, Gi2, and Gs in the inner surface Ci of the differential case C. The modes of the oil grooves according to these modified examples may be applied to the differential case C formed in an integral manner as in the second embodiment.

Although the embodiments of the present invention have been described hereinabove, the present invention is not limited to the embodiments, and the design of the invention can be variously changed can be variously within a scope not departing from the gist of the invention.

For example, the embodiments described above show that the differential device D is applied as a differential device for an automobile. However, in the present invention, the differential device D may be applied to vehicles different from automobiles and/or various mechanical devices different from vehicles.

Furthermore, the embodiments described above provide an example that the flange parts Cf, Cf1, Cf2 of the differential case C and the ring gear R are coupled to one another with two or more bolts B. However, in the present invention, the flange parts Cf, Cf1, Cf2 and the ring gear R may be coupled to one another by different coupling methods (for example, by welding).

The embodiments described above show that the oil introduction channels to introduce the oil outside the differential case C to the side gear support surfaces S1 S2 include the helical grooves 15, 16 (in the first embodiment and modified examples of the second embodiment) that are provided to the inner circumferential surfaces of the first and second bearing bosses Cb1, Cb2 of the differential case C and can exhibit a pumping action, and the clearances 30 (in the second embodiment) in the parts of the bearing bosses Cb1, Cb2 fitted with the output shafts 11, 12, respectively. However, the oil introduction channels are not limited to the embodiments, and may be, for example, grooves linearly provided in the inner circumferential surfaces of the respective bearing bosses Cb1, Cb2. When the oil introduction channels are the helical grooves 15, 16, the pumping action of the helical grooves 15, 16 introduces a large amount of the lubricating oil into the differential case C. It is particularly expected that the large amount of the lubricating oil smoothly flows through the pinion gear lubricating oil grooves Gp and are smoothly discharged.

Furthermore, the embodiments described above show that the inner surface oil grooves Gi, Gi1, Gi2 communicate with the oil introduction channels (the helical grooves 15, 16, and the clearance 30) through the side gear support surfaces S1, S2 (more specifically, the side gear lubricating oil grooves Gs). However, the inner surface oil grooves Gi, Gi1, Gi2 may directly communicate with the oil introduction channels through bypass oil channels bored in the differential case C (that is, not through the side gear lubricating oil grooves Gs and the side gear support surfaces S1, S2).

Still further, the embodiments described above show that the pinion gear lubricating oil grooves Gp, Gp′ do not communicate with the pinion shaft support holes 25 of the differential case C (that is, run at positions spaced apart from the respective pinion shaft support holes 25), whereby the oil flowing through the pinion gear lubricating oil grooves Gp, Gp′ can be surely prevented from leaking toward the pinion shaft support holes 25. In another embodiment, it is possible to implement a configuration in which a part of each of the pinion gear lubricating oil grooves Gp, Gp′ is laid across and communicates with a corresponding one of the pinion shaft support holes 25. In this case, even when there is more or less oil leakage from the pinion gear lubricating oil grooves Gp, Gp′ to the pinion shaft support holes 25, the pinion gear lubricating oil grooves Gp, Gp′ are not completely occupied by the pinion shaft 21. Thus, oil flow inside the pinion gear lubricating oil grooves Gp, Gp′ can be maintained to some extent, which can exhibit a desired effect of the present invention.

1. A differential device comprising:
a differential case rotatable about a first axial line;
side gears in pairs that are supported by the differential case in a freely rotatable manner about the first axial line;
two or more pinion gears supported by the differential case in a freely rotatable manner about at least one second axial line orthogonal to the first axial line, the two or more pinion gears mesh with the respective side gears in pairs; and
oil introduction channels provided to the differential case so as to enable introduction of lubricating oil from an outside of the differential case to respective side gear support surfaces of the inner surface of the differential case, the respective side gear support surfaces supporting back sides of the side gears,
wherein the inner surface of the differential case includes:
pinion gear support surfaces supporting back sides of the two or more pinion gears;
inner surface oil grooves, each inner surface oil groove being provided in the inner surface at a position outward of a corresponding one of the pinion gear support surfaces, and the each inner surface oil groove communicating with a corresponding one of the oil introduction channels;
pinion gear lubricating oil grooves provided in the respective pinion gear support surfaces, each pinion gear lubricating oil groove including one end opened to a corresponding one of the inner surface oil grooves; and
discharge channels, each discharge channel making another end of the corresponding one of the pinion gear lubricating oil grooves communicate with an internal space of the differential case.

2. The differential device according to claim 1, wherein the each pinion gear lubricating oil groove passes through a radially-inward specific area in a corresponding one of the pinion gear support surfaces, the radially-inward specific area being positioned radially inward of an imaginary circle that bisects a radial width of the corresponding one of the pinion gear support surfaces.

3. The differential device according to claim 1, wherein the each pinion gear lubricating oil groove is formed so as to linearly extend as viewed in a projection plane orthogonal to the second axial line, and intersects an imaginary straight line orthogonal to the first axial line and the second axial line as viewed in the projection plane.

4. The differential device according to claim 1,
wherein the differential case includes boss parts in pairs as parts integral with the differential case, each boss part being fitted with and supporting a corresponding one of output shafts in pairs so as to make the corresponding one of the output shafts freely rotatable, and each output shaft rotating with a corresponding one of the side gears in pairs in an interlocking manner,
wherein the boss parts include inner circumferential surfaces provided with the respective oil introduction channels,
wherein the oil introduction channels include a first oil introduction channel and a second oil introduction channel,
wherein first inner surface oil grooves of the inner surface oil grooves communicating with a first oil introduction channel of the oil introduction channels, first pinion gear lubricating oil grooves of the pinion gear lubricating oil grooves communicating with the respective first inner surface oil grooves, and first discharge channels of the discharge channels communicating with the respective first pinion gear lubricating oil grooves are included in first channels, and a second inner surface oil groove of the inner surface oil grooves communicating with a second oil introduction channel of the oil introduction channels, a second pinion gear lubricating oil groove of the pinion gear lubricating oil grooves communicating the second inner surface oil groove, and a second discharge channel of the discharge channels communicating with the second pinion gear lubricating oil groove are included in a second channel, and
wherein the first channels and the second channel are arranged in the inner surface of the differential case independently from each other.

5. The differential device according to claim 1,
wherein the differential case includes boss parts in pairs as parts integral with the differential case, each boss part being fitted with and supporting a corresponding one of output shafts in pairs so as to make the corresponding one of the output shafts freely rotatable, and each output shaft rotating with a corresponding one of the side gears in pairs in an interlocking manner,
wherein the boss parts include inner circumferential surfaces provided with the respective oil introduction channels,
wherein the oil introduction channels include a first oil introduction channel and a second oil introduction channel,
wherein first inner surface oil grooves of the inner surface oil grooves communicating with the first oil introduction channel and second inner surface oil grooves of the inner surface oil grooves communicating with the second oil introduction channel are provided in the inner surface of the differential case so as to communicate with each other through the respective pinion gear lubricating oil grooves,
wherein, when the lubricating oil is introduced into the pinion gear lubricating oil grooves from the first oil introduction channel through the first inner surface oil grooves, the second inner surface oil grooves function as the discharge channels, and when the lubricating oil is introduced into the pinion gear lubricating oil grooves from the second oil introduction channel through the second inner surface oil grooves, the first inner surface oil grooves function as the discharge channels.

6. The differential device according to claim 1,
wherein the differential case is formed as an integral body including an inner surface having a spherical shape and windows to allow the side gears and the two or more pinion gears to be assembled into the differential case therethrough, and
wherein the inner surface oil grooves and the pinion gear lubricating oil grooves are formed into one continuous line of groove along a circular arc about a specific axial line passing through a spherical surface center of the inner surface and at least one window of the windows.

7. The differential device according to claim 6,
wherein an outer circumferential part of the differential case is provided with a flange part to fix a ring gear thereto such that the flange part and one sides of the windows are aligned in a direction along the first axial line, the flange part protruding from the outer circumferential part of the differential case, and
wherein the specific axial line is tilted with respect to the first axial line, as viewed in a projection plane orthogonal to the second axial line, such that the specific axial line is gradually distanced from the flange part WO as being distanced from the first axial line in an area closer to the one widow, with respect to the first axial line that enables a cutting tool to be put in or taken out.

8. The differential device according to claim 6, wherein the discharge channels are formed into grooves provided in the inner surface of the differential case, and are formed into one continuous line of groove including the inner surface oil grooves and the pinion gear lubricating oil grooves along a circular art about the specific axial line.
